(19) United States
(12) Patent Application Publication
(10) Pub. No.: US 2020/0334719 A1
(43) Pub. Date: Oct. 22, 2020

(54) AUGMENTED INTELLIGENCE LEADING TO HIGHER DEAL ACCEPTANCE FOR DEALERSHIPS

(71) Applicant: Capital One Services, LLC, McLean, VA (US)

(72) Inventors: Christopher BORCHERS, Frisco, TX (US); Sandeep VANKA, Plano, TX (US); Nicholas DOLLE, McKinney, TX (US)

(21) Appl. No.: 16/389,088

(22) Filed: Apr. 19, 2019

(51) Int. Cl. G06Q 30/02; G06N 20/00; G06N 5/04; G06N 7/00

(52) U.S. Cl. CPC G06Q 30/0283; G06N 7/005; G06N 5/046; G06N 20/00

(57) ABSTRACT

Embodiments of the present disclosure provide systems, methods, and devices for utilizing an artificial intelligence engine to determine a probability of predictor variables satisfying a target condition are described. Example embodiments relate to a predictive model and development of a predictive model using an artificial intelligence system and/or machine learning techniques. Example embodiments of systems and methods may utilize AI based systems and models for facilitating communication and negotiation between multiple parties.

### FIELD OF THE INVENTION

This disclosure relates to artificial intelligence (AI)-based systems and methods for receiving a set of predictor variable values and determining a probability of the variable values satisfying a target condition.

### BACKGROUND

Currently, the process of purchasing a vehicle frequently involves multiple parties negotiating on multiple variables with little to no knowledge of what may be deemed an acceptable offer by the opposing party. In transactions involving many different variables, packaging of some sets of variables may frustrate the negotiation process resulting in less than optimal outcome for all parties.

In most vehicle negotiation processes, neither party has knowledge of the subjective importance any particular factor holds in the mind of the opposing party. This leads to significant amounts of wasted time and lower satisfaction in the overall outcome. Frustration in the purchasing process can lead to lower overall sales and an unfavorable opinion of sales staff, a seller or a dealership.

Therefore, a need exists for a system which facilitates communication and understanding between parties and provides the parties with an understanding of terms which may satisfy a given target condition.

### SUMMARY

Therefore, it is an object of this disclosure to describe artificial intelligence (AI) based systems and methods for developing predictive models which may be used to determine a probability that a given set of variables will satisfy a target condition. Such predictive models may be used to facilitate negotiated transactions. Each of these inventions seeks to provide actionable information related to one or multiple factors being considered in a multi-party conditional transaction. By providing information relating to previously known variables which associated with a target condition, the AI based systems and methods may facilitate future engagements. This results in a more positive user experience, increased overall satisfaction with the transaction experience, and/or a greater volume of transactions completed.

In some embodiments machine learning methods are used to develop a predictive model for a multi-party engagement based on information which may not be readily available to any single party.

In some embodiments, an artificial intelligence engine may be used to provide selections to a user based on a determined probability of user selections satisfying a target condition.

Embodiments of the present disclosure provide an artificial intelligence system comprising: a user interface; a data storage containing a plurality of predictor variables associated with a target condition wherein the predictor variables comprise data associated with user information and data associated with user terms; and an AI engine coupled to an application programming interface that enables the transmission of real time data. In operation, the AI engine receives user information data from one or more data sources; receives data from the user interface associated with a user term; applies a predictive model to the received user information data and user term data to determine a probability of the received data satisfying a target condition; and displays the probability of the received data satisfying the target condition on the user interface.

Embodiments of the present disclosure provide an artificial intelligence method comprising: receiving user information pertaining to a user; receiving proposed terms from the user; applying a predictive model to the received user information and proposed terms; determining, based on the predictive model, the likelihood that the received user information and proposed terms satisfy a target condition; and presenting the likelihood that the received user information and proposed terms satisfy a target condition to the user.

Embodiments of the present disclosure provide a device for facilitating negotiated purchasing, the device comprising: a user interface; an input device; a processor; and at least one database, containing data related to completed transactions and a plurality of predictor variables associated with the completed transactions, wherein the predictor variables include purchaser information, financing terms, and transaction terms. In some embodiments, the user interface prompts a user to input transaction terms using the input device; the processor receives transaction terms from the user interface, receives purchaser information from a database, receives lending terms from a database, and applies a predictive model to determine the probability of the received transaction terms, lending terms, and user information resulting in a completed transaction. In some embodiments, the processor also displays the determined probability on the user interface.

Further features of the disclosed design, and the advantages offered thereby, are explained in greater detail hereinafter with reference to specific example embodiments illustrated in the accompanying drawings.

### BRIEF DESCRIPTION OF THE DRAWINGS

FIG. 1 illustrates an artificial intelligence system according to an example embodiment.

FIGS. 2A, 2B, and 2C illustrate a series of user interfaces according to example embodiments.

FIG. 3 is a flow chart illustrating the operation of the artificial intelligence system according to an example embodiment.

FIG. 4 is a flow chart illustrating the operation the artificial intelligence system utilizing additional information and providing user feedback according to an example embodiment.

FIG. 5 is a flow chart illustrating the operation the artificial intelligence system providing user guidance and additional user term options according to an example embodiment.

### DETAILED DESCRIPTION OF EXAMPLE EMBODIMENTS

The present disclosure provides systems, methods, and devices for developing and utilizing AI systems, an AI engine, machine learning techniques, and predictive modeling facilitating the satisfaction of a target condition. Embodiments described herein utilize AI based systems and models for facilitating communication and negotiation between multiple parties.

In some on-line vehicle research applications, a user at a home computer logs on to a website to search for a vehicle. The user enters information relating to a desired vehicle into the website. In some models, once a user has input the options, features, and/or other variables desired in a vehicle, that information may be transmitted to a server or device associated with one or a plurality of sellers including, for example, dealerships. Upon receiving the information entered by the user, the seller may choose to contact the user in order to initiate a dialog regarding the purchase of a vehicle. The user and the seller may then engage in a series of back-and-forth negotiations and/or counter offers until an offer is made that comprises a set of options, features, and/or variables that is acceptable to both parties. In such models, neither the user, nor the dealership knows what variable may be subjectively important to the other party or lead to a reasonable probability of acceptance. This can lead to prolonged and frustrating negotiations, lower overall satisfaction with the process and/or outcome, and fewer total transactions overall.

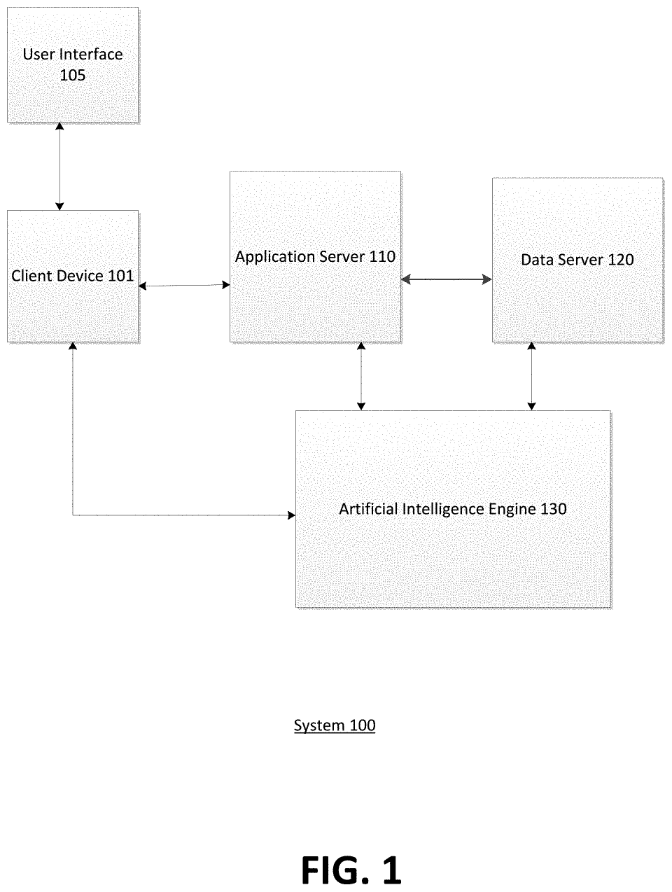

FIG. 1 illustrates an artificial intelligence system according to an exemplary embodiment. In this embodiment, the system includes a client device 101, an application server 110, at least one data server 120, and an artificial intelligence engine 130. Client device 101 may be, but is not limited to being a smartphone, laptop, desktop computer, tablet computer, personal digital assistants, thin clients, fat clients, Internet browsers, customized software application or kiosk. It is further understood that the client device may be of any type of device that supports the communication and display of data and user input. The present disclosure is not limited to a specific number of client devices, and it is understood that the system 100 may include a single client device or multiple client devices.

The memory may be a read-only memory, write-once read-multiple memory or read/write memory, e.g., RAM, ROM and EEPROM, and the client device 101 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

Client device 101 may further include wired or wireless data communication capability. These capabilities may support data communication with a wired or wireless communication network, including the Internet, a cellular network, a wide area network, a local area network, a wireless personal area network, a wide body area network, any other wired or wireless network for transmitting and receiving a data signal, or any combination thereof. This network may include, without limitation, telephone lines, fiber optics, IEEE Ethernet 902.3, a wide area network, a local area network, a wireless personal area network, a wide body area network or a global network such as the Internet. Client device 101 may also, but need not, support a short-range wireless communication interface, such as near field communication, radio-frequency identification, and Bluetooth.

Client device 101 further includes at least one display and input device. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the client devices that is available and supported by the client device 101, such as a touch-screen, keyboard, mouse, cursor-control device, touch-screen, microphone, digital camera, video recorder or camcorder. These devices may be used to enter information and interact with the system 100 as described herein.

The application server 110, data server 120, and AI engine 130 may be, or may be run on, dedicated server computers, such as bladed servers, or may be personal computers, laptop computers, notebook computers, palm top computers, network computers, mobile devices, or any processor-controlled device capable of supporting the system 100.

While FIG. 1 illustrates an application server 110, a data server 120, and an AI engine 130, it is understood that other embodiments may use multiple computer systems or multiple servers as necessary or desired to support the users and may also use back-up or redundant servers to prevent network downtime in the event of a failure of a particular server. It is further understood that in some embodiments, a plurality of additional data servers 121, 122, 123, may store information and/or data utilized by the AI engine.

In an embodiment, a data server 120 may contain user information data 230 including, but not limited to first name, last name, date of birth, home address, work address, phone number, income, tax return information, marital status, number of children, credit score, and/or criminal history. In some examples, user information data 230 may additionally or alternatively include the user's driving habits and/or the intended use of a vehicle, such as, for example, personal or commercial use, the expected number of miles driving in a given time period, and/or the expected driving conditions. Data server 120 may contain user information data from one or more credit bureaus or other reporting agencies. This may include data from a consumer reporting agency (e.g., TransUnion, Equifax, Experian, and Innovis), a business reporting agency (e.g., Dun & Bradstreet, Experian Business, Equifax Commercial, Cortera, Southeastern Association of Credit Management, and PayNet), a credit rating agency (e.g., Standard & Poor's, Moody's Investors Service, and Fitch Ratings), other data collection agencies (e.g., Small Business Financial Exchange, Inc. and Payment Reporting Builds Credit, Inc.), or a combination thereof. While the foregoing list of data sources is exemplary, it is understood that the present disclosure is not limited thereto, and data server 120 may include data from one or more U.S. or foreign agencies. In an embodiment, the data server 120 may store credit score and basic associated information.

In an embodiment, data server 120 may contain a series of predictor variables associated with a target condition. While this disclosure generally discusses the AI systems in the exemplary context of the target condition being the sale of a vehicle, it will be appreciated that a wide variety of target conditions and associated predictor variables may be utilized.

In some embodiments predictor variables include but are not limited to whether a vehicle is used or new, if a vehicle was previously leased or owned, if a vehicle was part of a rental and/or corporate fleet, make, model, year, condition, address, date, month, season, location, city, state, zip code, body style, trim package, user price, whole-sale price, invoice price, auction price, mileage, four-wheel drive, all-wheel drive, two-wheel drive, front-wheel drive, rear-wheel drive, automatic transmission, manual transmission, exterior color, exterior accents, exterior trim, interior color, interior accents, interior trim, interior materials, number of owners, previous accidents, theft history, fuel economy, vehicle reviews, vehicle star rating, owner satisfaction rating, manufacturer suggested retail price (MSRP), allow wheels, aluminum wheels, backup camera, Bluetooth connectivity, cargo attachments, air-conditioning, heating, vented seats, cooled seats, cloth seats, leather seats, power seats, navigation system, additional power connections, power mirrors, power steering, premium audio/video features, sport suspension, sunroof/moon roof, additionally technology package, cruise control, adaptive cruise control, lane change assist, financing terms, insurance rates, amount financed, annual percentage rate (APR), total monthly payment, manufacturer incentives, and/or additional products available for a vehicle, such as, for example, service contracts, GAP insurance, time and wheel protection, and/or extended warranties.

In some embodiments, user information is input by the user into a user interface running on the client device. User information data may be stored by the application server.

The AI engine 130 may be in data communication with the client device 101, user interface 105, application server 110, and/or data storage 120 and is configured to receive information related to at least one of user terms, seller inventory, user information data, financing terms, and/or insurance data. The AI engine 130 applies a predictive model to the received information and/or data in order to determine the probability or likelihood of a given set of data satisfying a target condition. The predictive model may include continuous learning capabilities that allow it to refit with more recent data as it becomes available.

In an embodiment, the predictive model may be a supervised learning model with a specified target condition and predictor variables. The target condition of the model may be whether a vehicle was sold. The predictor variables of the model may be selected from the data stored in data server or any other available data associated with the target condition. In some embodiments, the predictor variables utilized by the AI engine may be a subset of the available information. In addition, the subset of data used may increase, may decrease, or may otherwise be modified over time as the development of the predictive model continues.

The predictive model may be developed by machine learning algorithms. In some embodiments, the machine learning algorithms employed may include gradient boosting machine, logistic regression, neural networks, or a combination thereof, however, it is understood that other machine learning algorithms may be utilized. In some embodiments, the predictive model may be developed using historical data associated with a target condition.

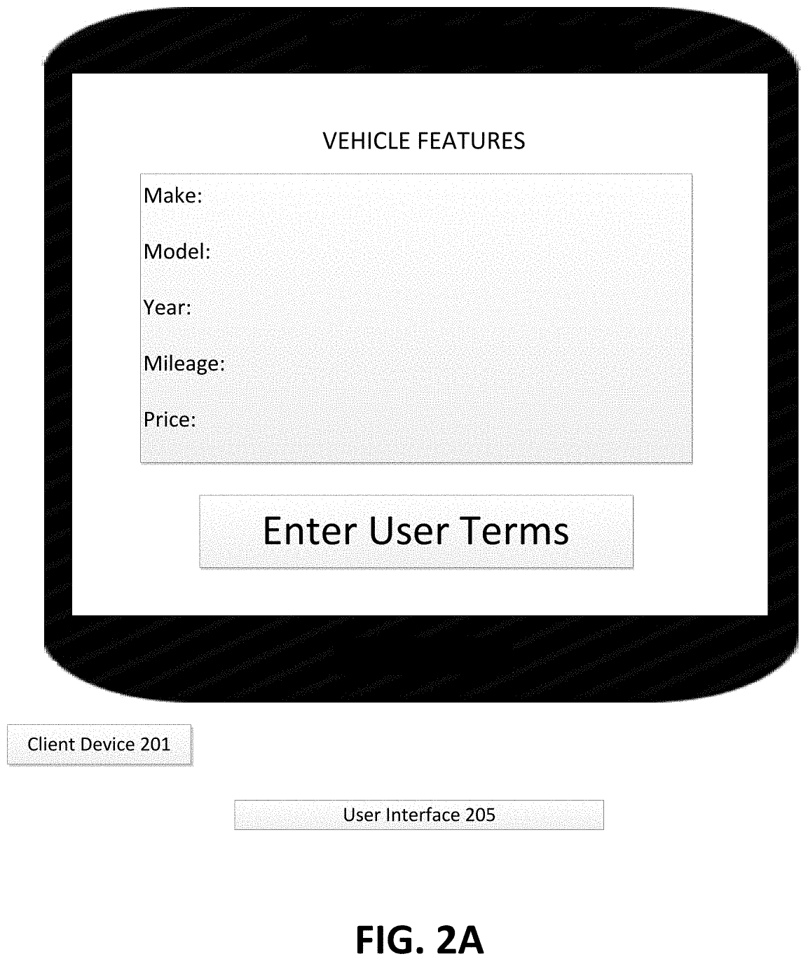

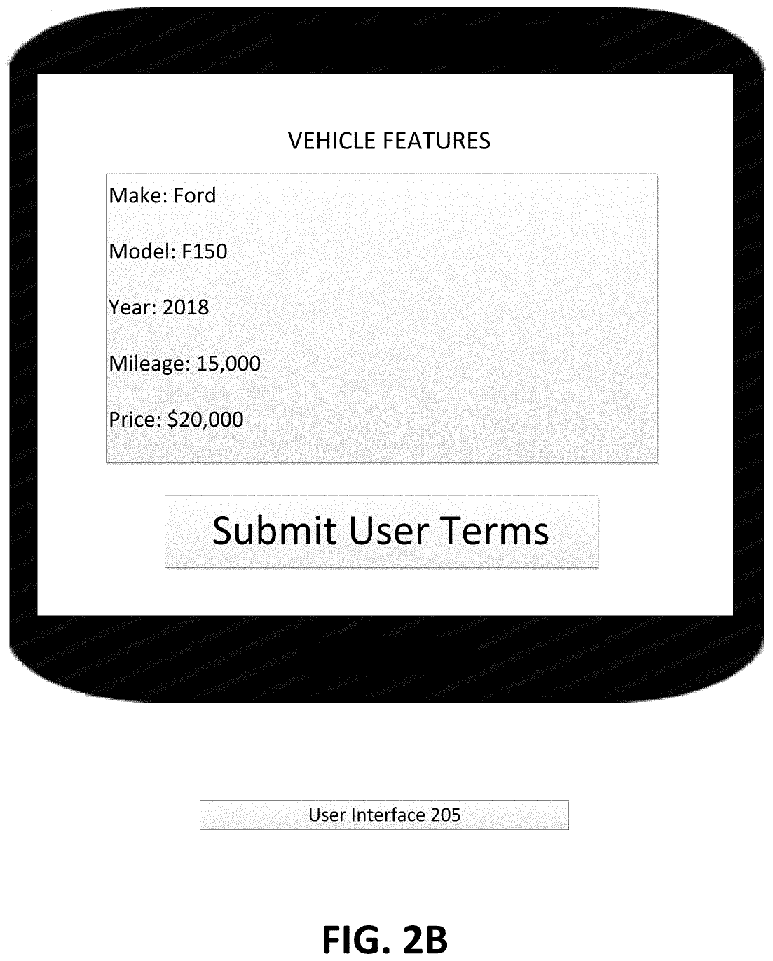

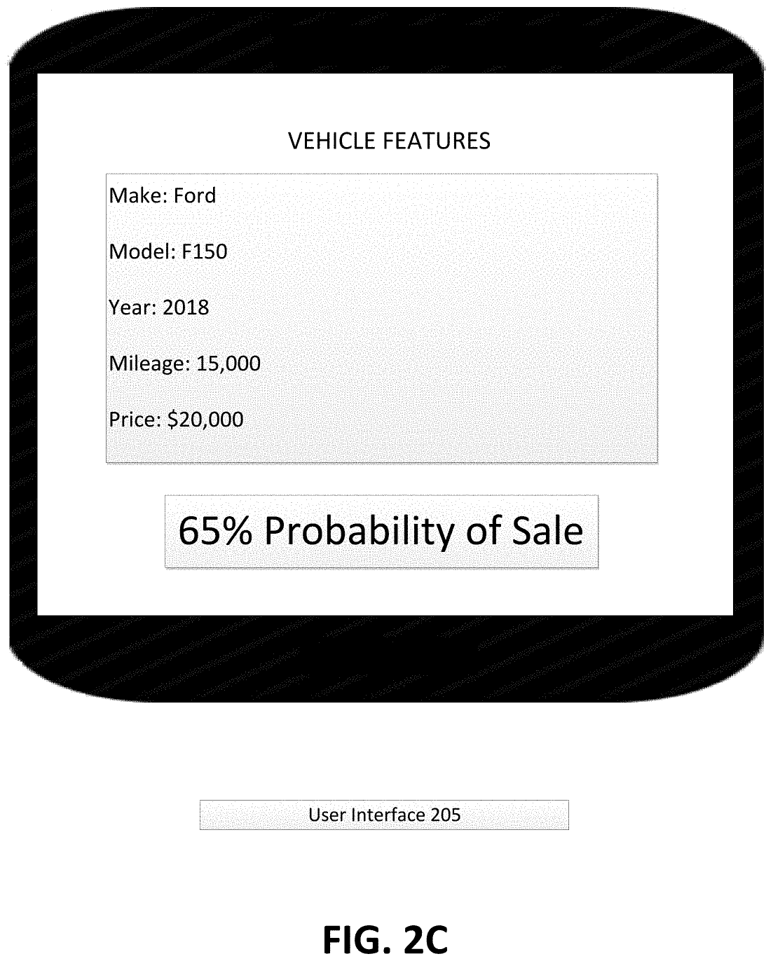

In one exemplary embodiment, as shown in FIG. 2A of the artificial intelligence system, user interface 205 may present the user with a selection of user terms 220 related to the purchase of a vehicle. Such user terms may include one or multiple variables relating to features the user desires in a vehicle or in a vehicle transaction. Once the user has entered user terms 220, as shown in FIG. 2B, and submitted the terms, the user interface 205 may be in data communication, through a client device 201, with an application server, data server, and/or an AI engine.

The AI engine may also be in data communication with a data server or a plurality of data servers, containing one or more predictor variables associated with target condition. A data server(s) may also contain user information, financing information, and/or insurance information.

The AI engine may then apply a predictive model to the user terms and/or other received information to determine the probability of the user terms satisfying a target condition, such as a completed transaction. As shown in FIG. 2C, the AI engine may then report the probability to the user.

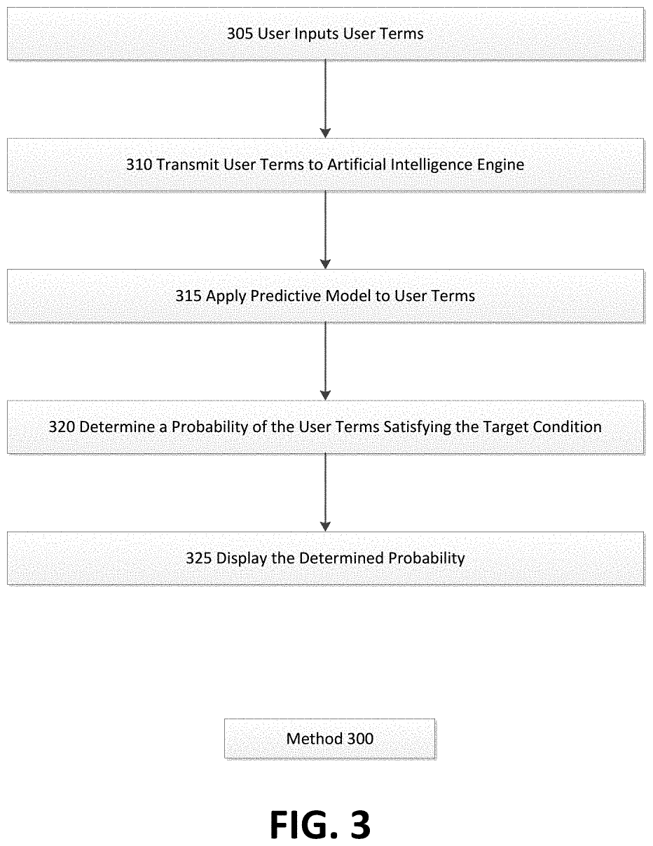

FIG. 3 is a flow chart illustrating an exemplary embodiment of the operation of the artificial intelligence system. The method 300 of FIG. 3 may reference the same or similar components as illustrated in FIG. 1, FIG. 2A, and FIG. 2B.

First, in step 305, the user inputs user terms. The user terms may be analogous to any predictor variable but are not immediately associated with a target condition. In some embodiments, the user terms may be options or features the user desires related to a vehicle, vehicle financing, and/or vehicle insurance.

Once the user enters user terms into the user interface, the user interface may then, in step 310, transmit the user terms as data to an AI engine. This step may involve transmitting data over a network. The AI engine, upon receiving the user terms may then, in step 315, apply a predictive model to the data it received from the user interface. This may include a statistical analysis of the user terms and any correlation between the various user terms which have been entered and a final outcome. In step 320 the AI engine determines a probability of the user terms satisfying a target condition, for example, the target condition of executing a transaction. This step may be performed by examining the user terms which have been transmitted and comparing those terms against a database of previous transactions in order to establish a statistical correlation. For example, if vehicles matching several of the entered user terms are frequently sold for a certain price, but in one instance, the user would like a significantly lower price, there may be a low probability of the user terms satisfying the target condition of purchasing the desired vehicle for the desired price. In step 325, the AI engine displays the determined probability on the user interface, thereby allowing the user to understand the likely outcome of his proposed user terms. This allows the user to revise the offer or, in some cases, indicates that the user will need to exert significant time and/or effort negotiating in order to purchase a vehicle corresponding to the transmitted user terms.

In some embodiments, the AI engine may receive user information, seller information, financing information, and/or insurance information.

Seller information may be analogous to any predictor variable associated with the operation and/or inventory of a seller. Seller information may include, but is not limited to, for example, availability, inventory, transportation costs, make, model, year, mileage, condition, address, date, month, season, location, city, state, zip code, retail price, whole-sale price, invoice price, auction price, and/or time a vehicle has been in the seller's possession.

Financing information may be analogous to any predictor variable associated with the financing, lending, borrowing and/or payment terms associated with a vehicle. Financing information may include, but is not limited to, for example, price, down payment, loan amount, repayment period, interest rate, APR, and/or monthly payment.

Insurance information may be analogous to any predictor variable associated with insurance and/or the cost of insurance for a vehicle. Insurance information may include, but is not limited to, for example, coverage amount, deductible, premium, term of coverage.

In one non-limiting example, a user would like to purchase a used luxury car that is less than three-years old, has less than 10,000 miles, and has leather seats. The user would like to pay less than $10,000. The user enters these user terms into the user interface. The user terms are transmitted to the AI engine. The AI engine applies a predictive model and determines an exemplary probability of less than 10% that a seller of a car matching the user terms would sell that car for the price the user entered. The AI engine displays this probability to the user. At this point, the user may refine the user terms in order to reach a higher probability that the terms will be accepted.

In some embodiments, the predictive model is based on predictor variables associated with previous vehicle sales. Using this information, the AI engine may compare the user terms input by the user into the user interface with predictor variables associated with previous successful transactions. If the user terms are very similar to previously successful transactions, the AI engine may determine that there is a higher likelihood of a seller accepting these terms. If the user terms are unlike any previously successful transaction, the AI engine may determine that there is a lower probability of a seller accepting the proposed user terms.

In some embodiments, the AI engine will analyze user information and financing information in a predictive model related to a user's potential financing options. Merely as one non-limiting example, if a user would like to pay less than $500 per month for a particular vehicle, a lender may be willing to finance the price of that vehicle on favorable terms based on the user's credit score. If the user has excellent credit and/or no criminal history, the user may receive financing at a low interest rate, thereby facilitating a lower monthly payment. If the user has a poor credit score and/or extensive criminal history, a lender may be unwilling to extend financing to the user, thereby lowering the probability that the information entered by the user will result in a successful transaction. In some examples, the financing terms may be a critical factor in completing a transaction. In some examples, financing information may be obtained from a financing institution, thereby offering a wider range of potential possibilities to a purchaser and/or a seller. For example, if a purchaser and seller are not able to agree on a final sales price, both sides may be able to reach an agreement if a financing institution is able to offer the seller a lower monthly payment, on a potentially higher sales price. By introducing additional variables related to the financing terms, a buyer and seller may have more opportunities to structure a transaction in a manner that is acceptable to all of the parties involved.

In some embodiments, the AI engine generates revised terms which have a higher likelihood satisfying a target condition. For example, if a set of user terms is determined to have a less than 20% chance of being accepted by a seller, the AI engine may suggest, for example, raising the price of the vehicle, increasing the mileage, and/or removing optional luxury features. It will be appreciated that the AI engine may analyze many individual predictor variables and recommend revised user terms associated with any one or any combination of such predictor variables.

In some embodiments, the AI engine may generate a plurality of revised user terms and present multiple potential options to the user. In such embodiments, the AI engine may not determine which features and/or variables are more important to the user but may reach a satisfactory outcome by presenting multiple potential options to the user. For example, one user may have a strict price limit. If the AI engine presents options which include raising the price of the car, these options may not be deemed satisfactory by the user. However, that user may be satisfied with an option which included an older vehicle, or a vehicle with fewer optional features. A different user may require a vehicle that is less than three-years old. This different user may be satisfied with a higher price option as long as the vehicle meets the age requirement. The AI engine may also display the determined probability that each of a plurality of options will be accepted by a seller. Such embodiments allow the user to select from a plurality of choices which have a determined probability of being accepted by a seller. Once the user is satisfied with a set of variables, either user generated or provided by the AI engine, the user may contact a dealership or seller, or the user may instruct the AI engine to transmit the selected set of variables to one or a plurality of sellers along with the user's contact information. In some embodiments, the AI engine may record the set of variables on a database and transmit a unique identifier to the seller, thereby allowing the seller to look up a given set of variables at the seller's convenience. In some embodiments, the user selects which sellers and/or dealerships to which the AI engine transmits the user's information and/or unique identifier.

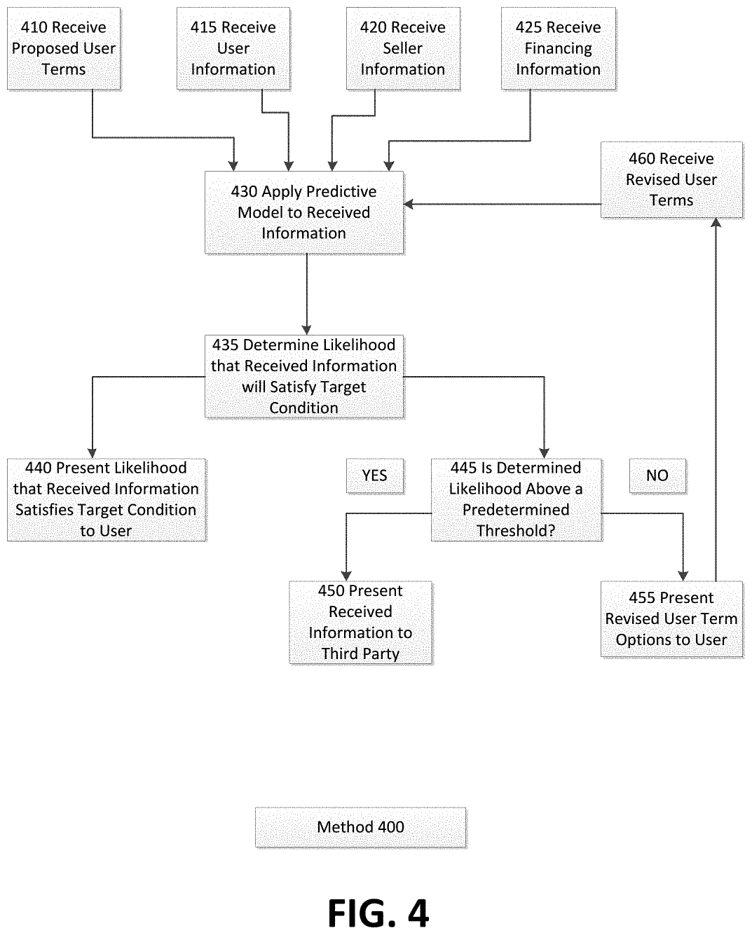

FIG. 4 is a flow chart illustrating an exemplary embodiment of the operation of the artificial intelligence system. Method 400 may reference the same or similar components or steps as illustrated in FIG. 1, FIG. 2A, FIG. 2B, and FIG. 3. In step 410, the AI engine receives user terms. These user terms may have been entered into a user interface by the user in near real time before being transmitted to the AI engine. In step 415, the AI engine receives user information. User information may include information about the particular user's credit history and may influence the lending options available to the user. The AI engine may receive the user information from a database, rather than from the user directly. In step 420, the AI engine receives seller information. This seller information may relate to the inventory of vehicles available in a particular area or from a particular seller. In some embodiments, the available inventory may be associated with the distance a vehicle is from the user. This distance may also be used to impact the final determination. In step 425, the AI engine receives financing information. This may include financing options available to a particular user or financing options generally available to all or most vehicle purchasers. This information may be received from a bank or from a seller that offers financing to its customers. In step 430, the AI engine applies a predictive model to the received information. This may involve a statistical analysis of the information received by the artificial intelligence engine in order to determine, in step 435, a likelihood that the received information will satisfy a target condition. In some embodiments, the target condition will be the purchase or sale of a vehicle. In step 440, the AI engine presents the determined likelihood to the user. This may inform the user whether or not the user terms entered are reasonable based on the user's particular user information. In step 445, the AI engine determines if the determined likelihood is above a predetermined threshold. If the answer is yes, in step 450, the AI engine presents the received information to a third party, such as, for example, a seller or lender. By pre-screening user terms using a threshold probability, a seller can avoid being notified of potential transactions which are not reasonable. In some embodiments, the seller can set the particular threshold value that it requires before being notified of the user terms. If the determined probability is not above a predetermine threshold, in step 455, the AI engine presents revised user term options associated with a high probability of satisfying a target condition to the user. This allows the user to understand what potential aspect of the user terms may be altered in order to have a higher likelihood of satisfying a target condition, such as, purchasing a vehicle. In step 460, the AI engine receives the user selected revised user terms and then applies the predictive model to the revised set of received information. By providing feedback regarding the likelihood that the user terms will satisfy a target condition, the user may continually revise the user terms until an acceptable set of user terms is established.

In some embodiments, the AI engine is in two-way communication with the user interface. In such embodiments, the AI engine may guide the user through a series of selections resulting in a deal that has a probability of being accepted that is within a defined range. The AI engine may ask the user to select the elements or characteristics which are most important to the user early in the process and use that information to present a series of choices with a probability of being acceptable to both the user and a seller. The AI engine may present the probability of a given set of variables being accepted by a seller substantially in real-time as the user makes selections. In one non-limiting example, the AI may ask the user to select a total monthly payment amount, mileage, and/or year of vehicle. Based on the user's answers, the AI engine may then present makes, models, and/or features that fit the user's criteria. The AI engine may present the probability of a deal being accepted by a seller based on the user's choices. This probability may be updated each time the user makes a new selection, thereby allowing the user to see the impact of each choice on the likelihood of the deal being accepted. By guiding the user through this process, the AI engine can assist the user in generating an offer that has a probability of being accepted that is within a certain range. In some embodiments, the AI system may be configured to guide the user towards choices that have at least about a 50% probability of being accepted, or at least about a 70% probability of being accepted, or at least about an 85% probability of being accepted. Once the user has selected a set of variables and the AI engine has determined that this set of variables has a probability of being accepted above a predetermined threshold, the AI engine may transmit information related to the user and/or the deal to one or multiple sellers. This process allows the user and the seller to begin the discussion of a vehicle purchase from an advanced position without spending a significant amount of time discussing or negotiating the vehicle or the transaction.

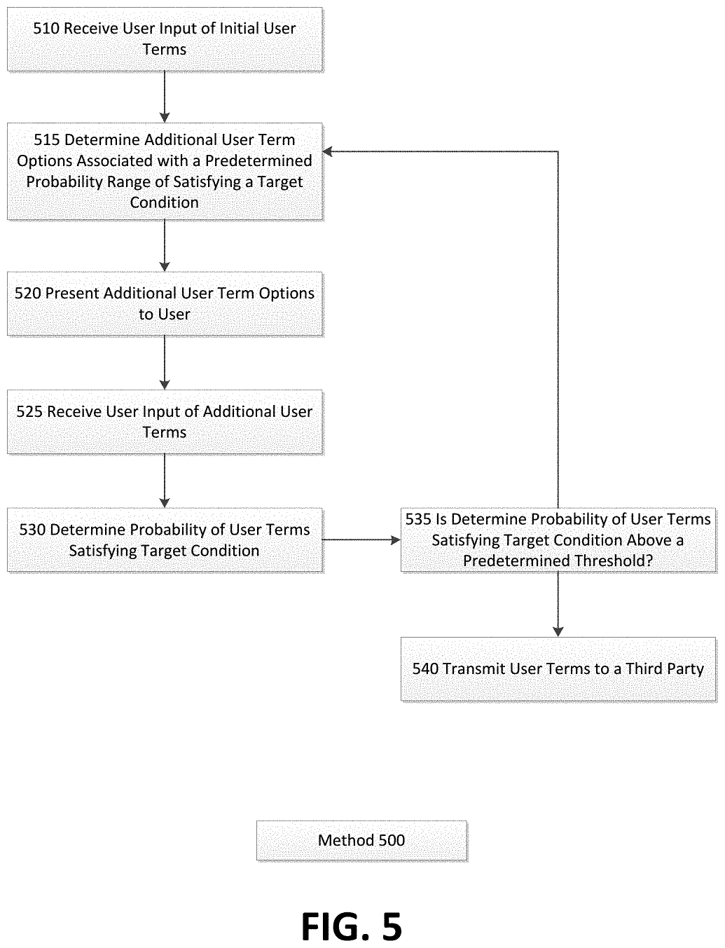

FIG. 5 is a flow chart illustrating an exemplary embodiment of the operation of the artificial intelligence system. Method 500 may reference the same or similar components or steps as illustrated in FIG. 1, FIG. 2A, FIG. 2B, FIG. 3, and FIG. 4. In step 510, the AI system receives initial user terms. This may include a type of vehicle the user wishes to purchase and any features the user believes are important. In step 515, the AI system determines additional user term options associated with a predetermined probability range of satisfying a target condition. This allows the AI engine to assist the user by completing a set of user terms based on the initial terms provided by the user. In step 520, the AI system presents the additional user term options to the user. This allows the artificial intelligence engine to guide the user toward a set of user terms which is more likely to result in a completed transaction. In step 525, the AI system receives user input of additional user terms. This allows the user to accept the guidance from the AI engine or to reject the proposed additional terms and substitute the user's own additional terms. In step 530, the AI system determines the probability of the user terms satisfying a target condition. In step 535, the AI system determines if the determined probability is above a predetermined threshold. If the answer is yes, in step 540, the AI system transmits the user terms to a third party, such as, for example, a seller. If the answer is no, the AI system goes back to step 515 and determines additional user term options associated with a predetermined probability range of satisfying a target condition. As the user is presented with and selects additional user term options, the AI system may guide the user towards a complete set of user terms with a certain probability of satisfying the target condition.

In some embodiments, in which the AI engine may transmit information to sellers, dealerships, and/or other third parties. In some embodiments, third parties may establish a required probability range before the AI engine transmits a set of user terms to the third party. For example, a seller may elect to only receive a set of user terms if the AI engine has determined there is a greater than 60% probability that the seller would accept that set of user terms. This allows both the user and the seller to avoid a significant amount of back-and-forth negotiation. Such embodiments may result in faster transactions, higher user satisfaction, higher seller satisfaction, and/or increased transaction volume.

In some embodiments of the disclosed system, an AI system receives user information relating to a specific user and a set of proposed user terms from the user. The AI system applies a predictive model to the user information and proposed user terms and determines the likelihood that the received user information and user terms will satisfy a target condition. In many embodiments, the target condition is the completed sale or lease of a vehicle. The AI system may then present the likelihood that the user terms and user information will lead to a completed sale or lease of a vehicle to the user.

In some embodiments, the predictive model is developed using a machine learning algorithm. In such embodiments, the machine learning algorithm may analyze a large data set of variables associated with a target condition and compare user information and/or user terms against the data set to determine a likelihood that the user information and/or terms will satisfy a target condition.

In some embodiments, the data set of information used to develop a predictive model may be stored on a remote server. In some embodiments, the data set includes information received from a vehicle transaction aggregator, a third party lender, a credit bureau, and/or at least one vehicle dealership. In preferred embodiments, the predictive model will incorporate data related to the specific user, data from at least one dealership, and data from at least one financial institution.

In some embodiments, the AI system is in communication with a separate data server containing financing information. The financing information data server may be configured to receive user information and/or user terms from a user interface and/or from the AI system. The financing server may additionally or alternatively be configured to provide potential financing options associated with a particular user and/or set of user terms to the AI system.

In some embodiments, the predictive model includes vehicle inventory data for a given area. In some embodiments, the AI system may know or be able to determine the user's location and adjust the likelihood of a set of user terms satisfying a target condition based on the relevant inventory within a predetermined distance from the user. In some embodiments, the user's location and the relevant inventory location may be integral to the determination of the likelihood that a set of user terms will lead to a successful vehicle transaction.

In some embodiments, the predictive model includes insurance information. In preferred embodiments, the AI system is in communication with a server containing information related to potential insurance terms for a user. The AI system may use this information to develop and/or adjust a predictive model. For example, when determining the likelihood of a set of user terms satisfying a target condition, the AI system may incorporate information regarding the amount of insurance coverage necessary for the vehicles described by the user terms and the cost associated with that level of insurance coverage. The AI system may present this information to the user and/or incorporate it into the monthly cost of purchasing a vehicle. Each of these factors may influence one or all of the other factors and/or the determined likelihood of a set of user terms satisfying a given condition.

In some embodiments, if a set of user terms leads to a successful vehicle transaction, the AI system may update a predictive model in order to reflect the completed transaction. This may allow the predictive model to develop over time and adapt to changes in cultural and/or societal values under differing conditions.

In some embodiments, the disclosed AI system may be used by a seller. Target condition such embodiments may include, but are not limited to, a number of transactions, number of vehicles sold, profit, net revenue, total revenue, inventory levels, number of new customers, and/or number of repeat customers. The seller may input user terms related to a vehicle a customer would like to purchase or related to a vehicle the seller would like to sell into a user interface. The AI system may receive the user terms from the user interface as well as any available user information related to the customer and/or available financing information. The AI system may be configured to generate a set of user terms with a likelihood of satisfying a target condition within a certain range. In some embodiments, the target condition may be whether or not the customer will accept the user conditions. By providing this information to the seller, the seller can more quickly arrive at a deal which is likely to be accepted by the customer and also acceptable to the seller. In some embodiments, the AI system may have detailed knowledge of the seller's inventory and be configured to generate deals which result in a certain amount of profit, manage the seller's inventory, lead to increased service revenue, or any other of a variety of target conditions which may be determined by the seller.

In some embodiments, both the buyer and seller work together to use the disclosed AI system. In such embodiments, neither party is required to trust the other as both parties can rely on the AI system to inform them of an objective probability that a given set of user terms which makes up a deal is likely to be accepted by a buyer or seller. Such embodiments may display, in real time, the probability that a given deal would be accepted by a buyer and/or seller in order to promote a high degree of transparency between the parties.

Some disclosed embodiments relate to an AI system for risk structuring. In some embodiments, the AI system receives information related to a specific user and information related to a vehicle that user would like to purchase. In some embodiments, the AI system may be configured to use the received information to determine potential financing options available to the user based on a level of risk determined to be acceptable to a lender.

In some embodiments, the disclosed AI system is applied to transactions which do not involve vehicles. In some embodiments, the AI system may facilitate real estate transactions, auction house transactions, flea market transactions, and/or any other negotiated transaction. In some embodiments, the disclosed AI system may be utilized by one party with or without informing the other party of the use of the AI system.

Throughout the specification, reference is made to an AI engine applying a predictive model. It will be understood that the AI engine may be any software, program, or application and that the predictive model may be any tool, database, dataset, software, program, or application which allows the AI engine to determine the likelihood or probability of a set of variables or terms satisfying a target condition.

Throughout the specification, reference is made to an AI engine receiving information from a variety of sources. It will be understood that the AI engine may receive information directly or indirectly from a database, server, memory and/or computer. The components form which the AI engine receives information or data may be located remotely, locally, or, in some cases, be integral to the AI engine.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An artificial intelligence (AI) system comprising:
a user interface;
a data storage containing a plurality of predictor variables associated with a target condition wherein the predictor variables comprise data associated with transaction terms; and
an AI engine configured for data communication with the data storage and with one or more data sources, wherein the AI engine:
receives user information data from the one or more data sources;
receives data from the user interface associated with a user term;
applies a predictive model to the received user information data and user term data to determine a probability of the received user information data and user term data satisfying the target condition, wherein the predictive model is trained using at least one neural network and a training dataset including at least one of financing information, insurance information, or seller information;
displays the probability of the received data satisfying the target condition on the user interface;
analyzes the predictor variables and generates a plurality of revised user terms associated with a higher probability of satisfying the target condition as compared to the original user terms;
displays the revised user terms and probability of the revised user terms satisfying the target condition on the user interface; and
transmits the revised user terms to a third party upon receiving an indication that the revised user terms are acceptable to the user.

2. (canceled)

3. (canceled)

4. (canceled)

5. (canceled)

6. The system of claim 1, wherein the user terms comprise at least one of vehicle make, vehicle model, vehicle year, vehicle features, price, or location.

7. The system of claim 1, wherein the predictor variables further comprises dealer inventory, dealer invoice price, time, date, location, and lending terms.

8. The system of claim 1, wherein the predictor variables further comprise data associated with lending terms and wherein the AI engine receives data from one or more data sources associated with lending terms.

9. The system of claim 8, wherein the AI engine generates a lending term based on the received user information and user terms, wherein the generated lending term and received data are associated with a probability of satisfying the target condition that is within a predetermined range.

10. The system of claim 1, wherein the AI engine receives data from the user interface associated with a user term in real time.

11. An artificial intelligence method comprising:
receiving user information pertaining to a user;
receiving proposed terms from the user;
applying a predictive model to the received user information and proposed terms, wherein the predictive model is trained using at least one neural network and a training dataset including at least one of financing information, insurance information, or seller information;
determining, based on the predictive model, the likelihood that the received user information and proposed terms satisfy a target condition; and
presenting the likelihood that the received user information and proposed terms satisfy a target condition to the user;
generating revised terms based on the proposed terms by revising at least one of the proposed terms;
applying the predictive model to the received user information and revised terms;
determining, based on the predictive model, the likelihood that the received user information and revised terms satisfy a target condition;
presenting the revised terms and the likelihood that the received user information and revised terms satisfy a target condition to the user; and
receiving an indication that the revised terms are acceptable to the user.

12. (canceled)

13. The artificial intelligence method of claim 12, further comprising:
using a target condition and a set of predictor variables for machine learning;
wherein the target condition is whether a transaction was completed, and
wherein the set of predictor variables includes at least one selected from the group of the user's credit score, the user's location, the user's income, a vehicle make, a vehicle model, a vehicle price, vehicle availability, and payment terms.

14. The artificial intelligence method of claim 13, further comprising:
providing a database of completed transactions and data associated with completed transactions for use in the set of predictor variables.

15. The artificial intelligence method of claim 11, further comprising providing feedback for the predictive model by:
recording whether the received user information and proposed terms lead to a satisfied target condition; and
updating the predictive model.

16. (canceled)

17. The artificial intelligence method of claim 11, further comprising:
transmitting the received user information and revised terms to a server;
receiving lending terms based on the transmitted user information and revised terms from the server;
applying a predictive model to the received user information, revised terms, and lending terms; and
determining, based on the predictive model, the likelihood that the received user information, revised terms, and lending terms satisfy a target condition.

18. The artificial intelligence method of claim 11, further comprising:
receiving inventory information and dealer pricing information from a database; and
applying a predictive model to the received user information, revised terms, inventory information, and dealer pricing information;
determining, based on the predictive model, the likelihood that the received user information, revised terms, inventory information, and dealer pricing information satisfy a target condition.

19. The artificial intelligence method of claim 18, further comprising:
upon determining the likelihood of the received user information, revised terms, inventory information, and dealer pricing information satisfying a target condition is within a predetermined range, transmitting user information, and revised terms to a dealer.

20. A device for facilitating negotiated purchasing, the device comprising:
a user interface;
an input device;
a processor; and
at least one database, containing data related to completed transactions and a plurality of predictor variables associated with the completed transactions, wherein the predictor variables include purchaser information, financing terms, and transaction terms;
wherein the user interface prompts a user to input transaction terms using the input device, and
wherein the processor receives transaction terms from the user interface, receives user information from a first data source, and receives lending terms from a second data source, and applies a predictive model to determine a first probability of the received transaction terms, lending terms, and user information resulting in a completed transaction, wherein the predictive model is trained using at least one neural network and a training dataset including at least one of financing information, insurance information, or seller information; and
wherein the processor generates revised transaction terms based on the received transaction terms by revising at least one of the received transaction terms, applies the predictive model to the revised transaction terms, and determines, based on the predictive model, a revised probability of the revised transaction terms, lending terms, and user information resulting in a completed transaction; and
wherein the processor displays the revised transaction terms and the determined revised probability on the user interface and receives an indication that the revised transaction terms are acceptable to the user.

21. The system of claim 1, wherein the financing information comprises at least one of price, down payment, loan amount, repayment period, interest rate, APR, or monthly payment.

22. The system of claim 1, wherein the insurance information comprises at least one of coverage amount, deductible, premium, or term of coverage.

23. The system of claim 1, wherein the seller information comprises at least one of availability, inventory, transportation costs, make, model, year, mileage, condition, location, city, retail price, whole-sale price, invoice price, auction price, or time a vehicle has been in a seller's possession.
